(19) United States
(12) Patent Application Publication
(10) Pub. No.: US 2014/0022222 A1
(43) Pub. Date: Jan. 23, 2014

(54) DIFFUSER WITH A DYNAMICALLY TUNABLE SCATTERING ANGLE

(71) Applicants: Huei Pei Kuo, Cupertino, CA (US); Jong-Souk Yeo, Incheon (KR)

(72) Inventors: Huei Pei Kuo, Cupertino, CA (US); Jong-Souk Yeo, Incheon (KR)

(21) Appl. No.: 13/982,730

(22) PCT Filed: Jan. 31, 2011
(86) PCT No.: PCT/US11/23256

§ 371 Date: Oct. 8, 2013

(51) Int. Cl. G09G 5/14; G02B 27/22; G02B 5/02

(52) U.S. Cl. CPC G09G 5/14; G02B 5/02; G02B 27/22
USPC 345/205; 359/599; 29/428

(57) ABSTRACT

A dynamically tunable diffuser having a dynamically tunable scattering angle is provided. The dynamically tunable diffuser has a first diffuser having a first series of microstructures and at least one second diffuser having a second series of microstructures that is rotated relative to the first series of microstructures to provide an angle offset between the first diffuser and the at least one second diffuser. The first diffuser and the at least one second diffuser are integrated together in a display screen to provide good quality, continuous 3D images to viewers regardless of their position and height.

### BACKGROUND

Light field displays have emerged to provide viewers a more accurate visual reproduction of three-dimensional (“3D”) real-world scenes without the need for specialized viewing glasses. Such displays emulate a light field, which represents the amount of light traveling in every direction through every point in space. The goal is to enable multiple viewers to simultaneously experience a true 3D stereoscopic effect from multiple viewpoints, by capturing a light field passing through a physical surface and emitting the same light field through a reflective display screen. Doing so has the potential to revolutionize many visual-based applications in areas as diverse as entertainment, business, medicine, and art, among others.

Light field displays typically include an optical diffuser to spread the incident light in the display screen into a range of angles and thereby generate multiple views. The tailoring of the angular distribution of a diffuser may be accomplished through microstructures on its surface, such as, for example, microstructures forming a sinusoidal pattern. Different applications often require different scattering angles. For some glasses-free, continuous 3D applications, the scattering angle needs to be very small in the horizontal direction (e.g., smaller than one degree), and large in the vertical direction (e.g., over thirty degrees). If multiple projectors are used, the horizontal scattering angle of the diffuser also needs to be matched to the angular separation of the projectors to eliminate handing and other artifacts in the displayed images.

### BRIEF DESCRIPTION OF THE DRAWINGS

The present application may be more fully appreciated in connection with the following detailed description taken in conjunction with the accompanying drawings, in which like reference characters refer to like parts throughout, and in which:

FIG. 1 illustrates an example of a diffuser for use in a dynamically tunable diffuser;

FIG. 2 illustrates a schematic diagram showing a dynamically tunable diffuser formed with two diffusers of FIG. 1;

FIG. 3 illustrates a schematic diagram showing the optics in the vertical plane of an example continuous 3D display system;

FIG. 4 illustrates an angular distribution of light reflected from a scattering surface used in the dynamically tunable diffuser when the scattering surface is illuminated with a laser;

FIG. 5 is an example flowchart for fabricating a diffuser with a dynamically tunable scattering angle for use in a glasses-free, continuous 3D display;

FIG. 6 is a schematic diagram of an example dynamically tunable diffuser;

FIG. 7 is a schematic diagram of another example dynamically tunable diffuser;

FIG. 8 is a schematic diagram of another example dynamically tunable diffuser;

FIG. 9 is a schematic diagram of another example dynamically tunable diffuser; and

FIG. 10 illustrates a display screen having a dynamically tunable diffuser.

### DETAILED DESCRIPTION

An optical diffuser is disclosed having a dynamically tunable scattering angle. An optical diffuser, as generally described herein, is any surface that diffuses (i.e., spreads out) or scatters incident light into a range of angles. The diffuser may be used in front or rear projection display systems to provide a glasses-free, continuous 3D experience to viewers.

In various embodiments, the dynamically tunable diffuser includes at least two diffusers having a scattering surface, each diffuser with a scattering angle of nearly zero (e.g., smaller than one degree) in the horizontal direction and a relatively large angle (e.g., larger than thirty degrees) in the vertical direction. The scattering surfaces contain a series of microstructures or grooves that are able to produce asymmetrical diffusing patterns. The microstructures in the at least two diffusers for the diffusers themselves) are rotated relative, to each other to create a small angle offset. The total scattering angle of the dynamically tunable diffuser may be controlled reliably and easily by the amount of the angular rotation.

As described herein below in more detail, one diffuser may be made of a reflective material including a reflective metal or a metalized diffusing surface, such as, for example, brushed stainless steel, brushed aluminum, or aluminized Delrin. The other diffuser(s) may be formed on a transparent substrate, such as for example, a plastic substrate manufactured with roll-to-roll technology, a glass substrate, a composite glass-plastic substrate, a hybrid substrate (e.g., woven or plastic layered outside of glass) or any other transparent substrate having mechanical and thermal stability for acting as a diffuser. Alternatively, all diffusers may be formed on one or more transparent substrates. The diffusers are integrated together in such a way that a rotation angle is formed between their respective microstructures. The rotation angle may be set at a default angle specified at fabrication, or it may be tuned in real-time by a viewer.

It is appreciated that embodiments of the dynamically tunable diffuser described herein below may include additional features. Some of the features may be removed and/or modified without departing from a scope of the diffuser. It is also appreciated that, in the following description, numerous specific details are set forth to provide a thorough understanding of the embodiments. However, it is appreciated that the embodiments may be practiced without limitation to these specific details. In other instances, well known methods and structures may not be described in detail to avoid unnecessarily obscuring the description of the embodiments. Also, the embodiments may be used in combination with each other.

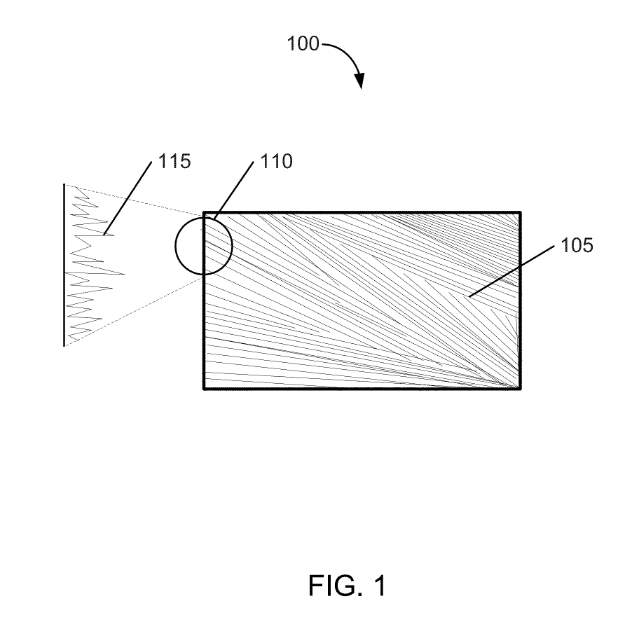

Referring now to FIG. 1, an example of a diffuser for use in a dynamically tunable diffuser is illustrated. Diffuser 100 contains a series of microstructures or grooves 105 extending throughout one of its surfaces, such as the top or bottom surface, denoted herein as the scattering surface. The microstructures 105 may form any pattern on the diffuser 100, including a random one. A cross-section 110 of the scattering surface in diffuser 100 shows one example of such a random pattern 115. The random pattern 115 shows that the microstructures 105 in the diffuser 100 have a given depth and a given spacing between them. In one embodiment, the spacings and depths are very small, such as, for example, 1-5 μm.

The diffuser 100 may be made of various materials, including, for example, reflective diffusing surfaces (e.g., reflective metal or metalized diffusing surfaces), or transparent substrates (e.g., plastic, glass or composite/hybrid substrates). The dynamically tunable diffuser described herein below is formed of at least two such diffusers, each with a scattering angle of nearly zero (e.g., smaller than one degree) in the horizontal direction and a relatively large angle (e.g., larger than thirty degrees) in the vertical direction. The at least two diffusers 100 are integrated together in such a way that a tunable angle is formed between them. In one embodiment, two diffusers may be integrated together in a single transparent substrate.

It is appreciated that the microstructures 105 in the diffuser 100 may form any pattern and be of any depth. For example, the microstructures 105 may form a random pattern, a sinusoidal pattern, and so on, be of different or equal depths, and have equal or different spacings between them. Regardless of their pattern/depth/spacing, it is appreciated that the microstructures 105 extend throughout the diffuser 100 such that the scattering angle in the horizontal direction is nearly zero (e.g., smaller than one degree) and the scattering angle in the vertical direction is relatively large (e.g., larger than thirty degrees).

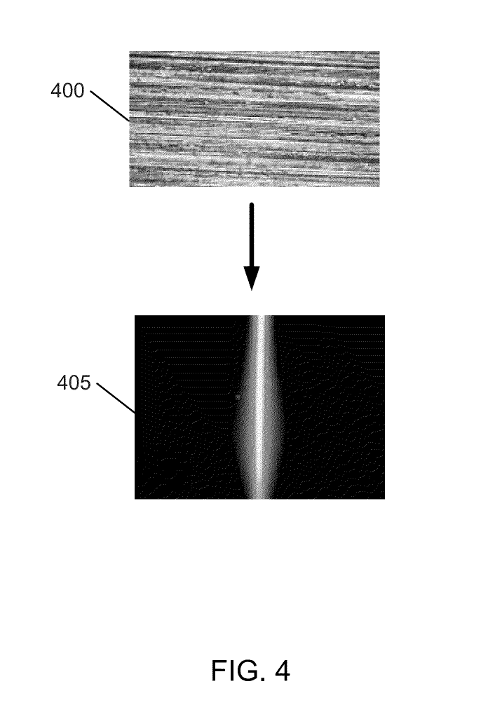

It is appreciated that the microstructures 105, as shown in FIG. 1, are for purposes of illustration only. For example, FIG. 1 shows that the microstructures are oriented somewhat random orientations. In practice, the microstructures used in the diffuser 100 may be better aligned than as shown in the figure (such as the microstructures in FIG. 4), to guarantee the desired angular characteristics (near zero scattering angle along the horizontal direction and a large angle along the vertical direction). In one embodiment, the microstructures may be oriented in the same direction, but their depth, spacing and cross sectional shapes may be random to form the nearly zero scattering angle in the horizontal direction.

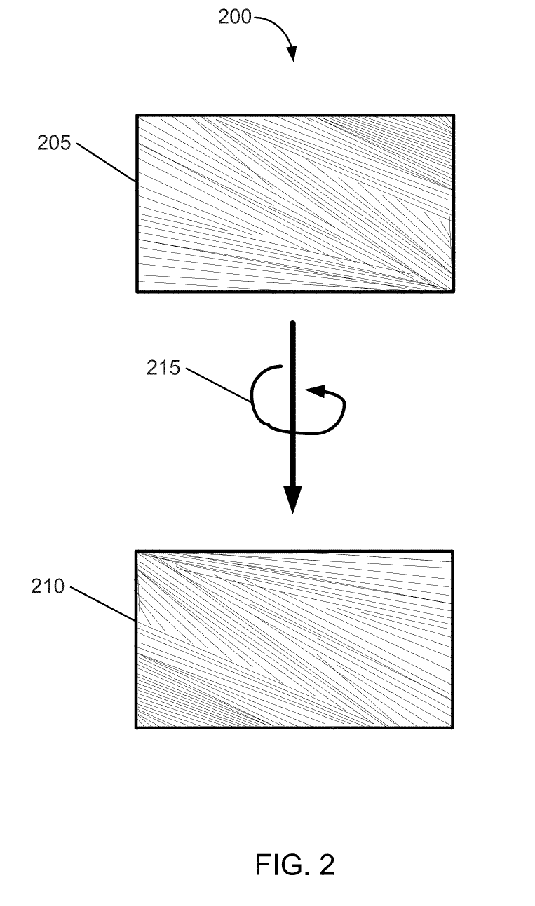

FIG. 2 illustrates a schematic diagram showing how a dynamically tunable diffuser is formed with two diffusers of FIG. 1. Dynamically tunable diffuser 200 has a diffuser 205 and a diffuser 210. The diffuser 210 is positioned such that its microstructures are rotated by a tunable angle 215 relative to the microstructures in the diffuser 205. As described in more detail herein below, the diffuser 205 and the diffuser 210 may be integrated in various ways.

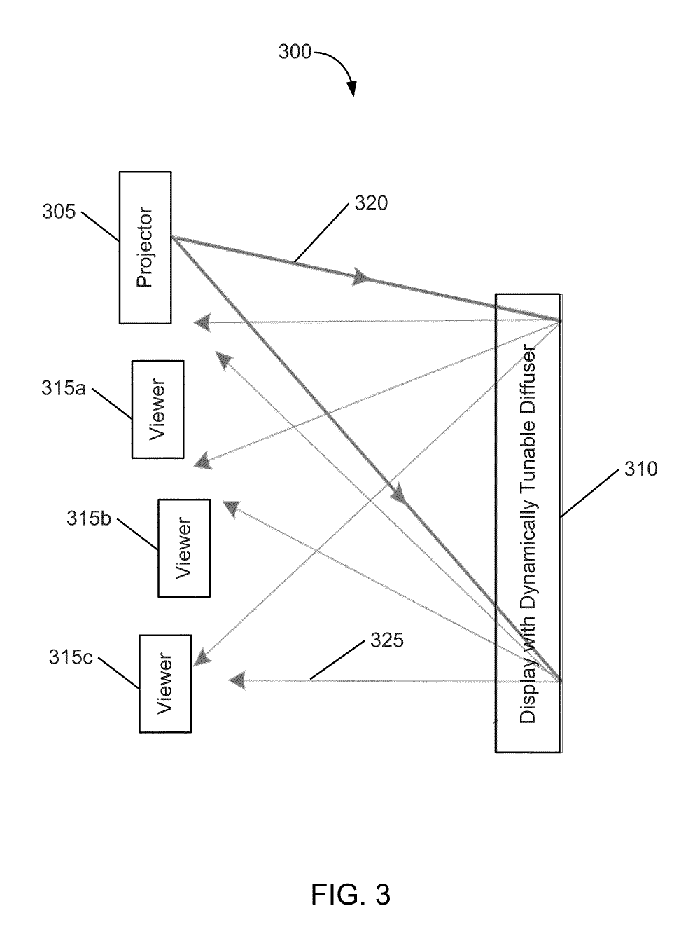

Both diffusers 205 and 210 have a nearly zero scattering angle in the horizontal direction and a large angle in the vertical direction. This angle requirement is a result of the optics necessary for providing continuous, 3D images to viewers. For example, FIG. 3 illustrates a schematic diagram showing the optical characteristics of light diffusion or scattering in a vertical plane of an example continuous 3D display system. Display system 300 is an example of a front-projection display system having a projector 305 and a display screen 310, with the projector 305 placed in front of the display screen 310. Display screen 310 is a reflective screen with a dynamically tunable diffuser, such as, for example, the dynamically tunable diffuser 200 of FIG. 2 having two diffusers.

Viewers 315a-c having different heights and at different positions face the display 310 to experience glasses-free, continuous 3D images projected from projector 305. Because the viewers 315a-c may have different heights, the incident light 320 coming from projector 305 needs to be reflected hack with light rays 325 that can reach any viewer at any position and height. Doing so requires that the light rays 325 be broadly distributed by the display screen 310 in the vertical direction. On the other hand, the display screen 301 scatters incident illumination from projector 305 into a narrow horizontal angular distribution such that the reflected illumination is observed by only one of the eyes of a binocular viewer. Having a diffuser in display screen 310 with a nearly zero scattering angle in the horizontal direction and a large angle in the vertical direction enables the viewers 315a-c to experience the desired continuous 3D images.

It is appreciated that the front-projection display system 300 is shown for illustration purposes only. Other display systems (e.g., rear-projection display systems) may also include the dynamically tunable diffuser described herein to achieve the desired continuous 3D effect. It is also appreciated that display systems having the dynamically tunable diffuser may be used with one or multiple projectors.

FIG. 4 illustrates the angular distribution of light reflected from a scattering surface used in the dynamically tunable diffuser when the scattering surface is illuminated with a laser. The scattering surface 400 has a nearly zero scattering angle in the horizontal direction and a scattering angle in the vertical direction of approximately ninety degrees. Illuminating this scattering surface 400 with a laser produces the reflected light distribution 405, which shows a broad light spread in the vertical direction and a very narrow cone angle (ideally zero) in the horizontal direction.

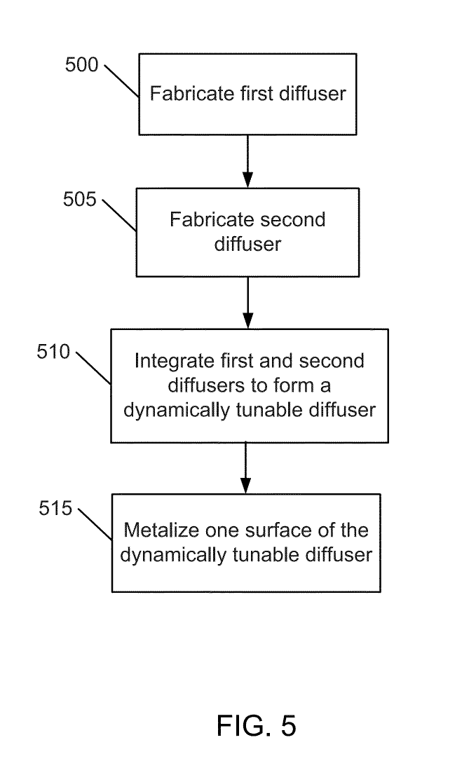

Referring now to FIG. 5, a flowchart for fabricating a diffuser with a dynamically tunable scattering angle for use in a glasses-free, continuous 3D display is described. First, a diffuser having a scattering surface with a nearly zero smaller than one degree) scattering angle in the horizontal direction and a large angle (e.g., larger than thirty degrees) in the vertical direction is fabricated (500). As described above with reference to FIG. 1, the scattering surface includes a series of microstructures or grooves extending throughout its surface. The microstructures may form any pattern on the scattering surface, including a random one, and may be of equal or different depths and have equal or different sized spacings between them. The diffuser may be fabricated of a reflective material, such as, for example, a reflective meal or a metalized diffusing surface, including brushed stainless steel, brushed aluminum, or aluminized Delrin, among others, or the diffuser may be fabricated by replicating the microstructures onto a transparent substrate.

Next, another diffuser is fabricated such that it has the same microstructures of the first diffuser but rotated by a tunable angle (505). In this case, this diffuser is fabricated by replicating the rotated microstructures onto a transparent substrate. This transparent substrate may be the same substrate used for the first diffuser (if fabricated in this manner), in which case the diffusers are formed on opposite surfaces of a single transparent substrate (as shown in FIG. 9). Alternatively, this other diffuser may be formed of a separate transparent substrate.

It is appreciated that the microstructures in a transparent substrate may be either directly embossed onto the substrate using a thermal embossing process, or using a polymeric resin with an imprinting process followed by curing the resin with an UV or thermal process.

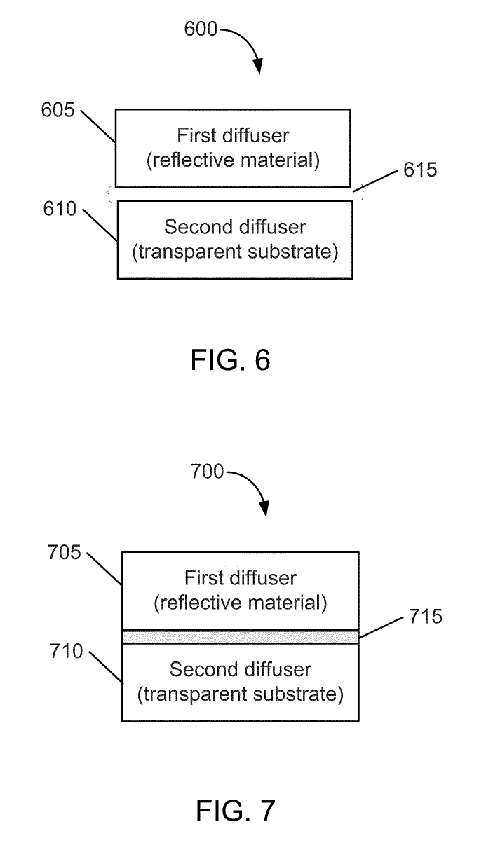

If necessary (i.e., if the diffusers are not on the same substrate), the diffusers are then integrated together to form a dynamically tunable diffuser (510). The integration, as described below with reference to FIGS. 6-9, may be achieved in various ways, depending on the materials used to fabricate the diffusers. Lastly, one surface of the dynamically tunable diffuser may be coated with a thin layer (˜<1 μm), of aluminum (i.e., aluminized) or other reflective metal (e.g., silver) to turn it into a reflective diffuser (515). Further, a thin passivation layer such as silicon dioxide may be deposited on top of the reflective layer to provide better reflectance and stability.

In one embodiment, the angle of rotation between the microstructures of the second diffuser and the microstructures of the first diffuser may be set at a default value upon fabrication. In another embodiment, the tunable angle may be tuned by a viewer of the display by, for example, controlling a remote or knob that changes the mechanical placement of the two diffusers relative to each other.

FIGS. 6-9 show different embodiments of the dynamically tunable diffuser. The dynamically tunable diffuser 600 of FIG. 6 is formed with a first diffuser 605 that is made of a reflective material (e.g., brushed stainless steel) and a second diffuser 610 that is made of a transparent substrate. Both diffusers 605-610 have a nearly zero (e.g., smaller than one degree) scattering angle in the horizontal direction and a large angle (e.g., larger than thirty degrees) in the vertical direction. Both diffusers 605-610 also have a series of microstructures or grooves extending throughout one of their surfaces (e.g., top or bottom surfaces). The microstructures in the diffuser 605 are replicated in the transparent substrate of the diffuser 610 such that they are rotated relative to the microstructures in the diffuser 605.

In this embodiment, a small gap 615 is present between the diffuser 605 and the diffuser 610 to allow the diffuser 610 to be rotated in real-time relative to the diffuser 605. The rotation can be tuned by a viewer by, for example, using a remote control to adjust the rotation of the diffuser 610. A mechanical mechanism (not shown) may be used in the diffuser 600 to control the rotation of the diffuser 610 upon operation of the remote control by the viewer.

It is appreciated that dynamically tunable diffuser 600 is in effect a glasses-free, continuous 3D display screen. It is also appreciated that enabling the viewer to dynamically adjust the rotation (and therefore to dynamically adjust the scattering angle of the diffuser 600) results in good quality images without undesirable variations in image brightness or other artifacts. Viewers are therefore able to experience continuous 3D images from a wide range of positions and viewing angles without any detriment in image quality that may result from a change in their position relative to the dynamically tunable diffuser 600.

FIG. 7 shows another embodiment of an example dynamically tunable diffuser. In this case, the dynamically tunable diffuser 700 has a first diffuser 705 also made of a reflective material (similar to diffuser 605 in FIG. 6) and a second diffuser 710 made of a transparent substrate (similar to diffuser 705 in FIG. 6). Again, both diffusers 705-710 have a nearly zero (e.g., smaller than one degree) scattering angle in the horizontal direction and a large angle (e.g., larger than thirty degrees) in the vertical direction. Both diffusers 705-710 also have a series of microstructures or grooves extending throughout one of their surfaces. The microstructures in the diffuser 705 are replicated in the transparent substrate of the diffuser 710 such that they are rotated relative to the microstructures in the diffuser 705.

In this embodiment, rather than having a small gap between the diffuser 705 and the diffuser 710 similar to gap 615 in FIG. 6, the diffuser 705 and the diffuser 710 are integrated together by curing an adhesive (e.g., epoxy) between them. The adhesive can be index matched to minimize Fresnel reflection losses from the diffusers 705 and 710. In doing so, the angle offset between the diffuser 705 and the diffuser 710 becomes set at fabrication and cannot be tuned in real-time. Different diffuser 700s may therefore be manufactured with different angle offsets, allowing viewers to select which angle offset best fits their continuous 3D needs at the time of purchase of a display screen formed with a diffuser 700.

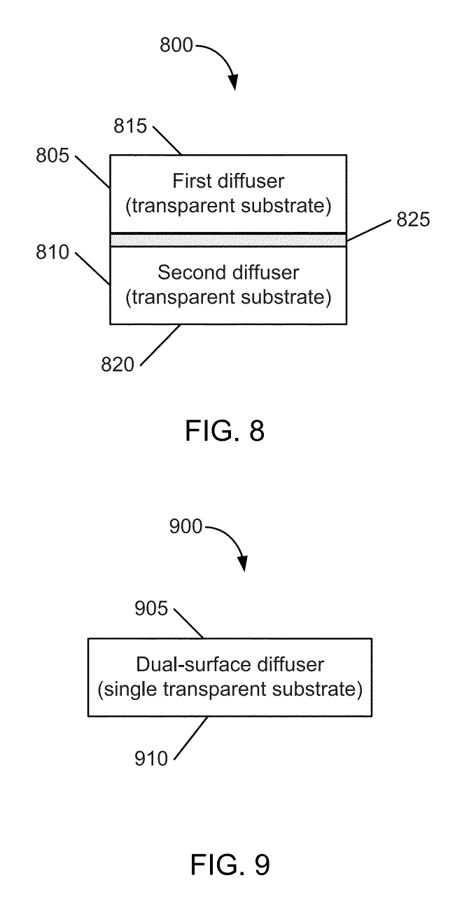

Another embodiment of an example dynamically tunable diffuser is illustrated in FIG. 8. In this embodiment, the dynamically tunable diffuser 800 has a first diffuser 805 that is made of a transparent substrate and a second diffuser 810 that is made of another transparent substrate. Again, both diffusers 805-810 have a nearly zero (e.g., smaller than one degree) scattering angle in the horizontal direction and a large angle (e.g., larger than thirty degrees) in the vertical direction. Both diffusers 805-810 also have a series of microstructures or grooves extending throughout their surfaces. The microstructures in the diffuser 805 are replicated in the transparent substrate of the diffuser 810 such that they are rotated relative to the microstructures in the diffuser 705.

The microstructures in the diffuser 805 are disposed along a surface 815, while the rotated microstructures in the diffuser 810 are disposed along an opposite surface 820 of the diffuser 810. Similar to the embodiment in FIG. 7, the diffuser 805 and the diffuser 810 are integrated together by curing an adhesive 825 (e.g., epoxy) between them.

FIG. 9 illustrates another embodiment of an example dynamically tunable diffuser. In this embodiment, the dynamically tunable diffuser 900 is a dual-surface diffuser made of a single transparent substrate such that microstructures are formed on the opposing surfaces 905 and 910 of the diffuser 900. The microstructures of one surface, e.g., surface 905, are replicated, on the other surface, e.g., surface 910, such that an angle offset is formed between them (that is, the microstructures of one surface are rotated relative to the microstructures of the other surface).

In one embodiment, the microstructures are formed by embossing the opposing surfaces 905 and 910 on both sides. The surfaces 905 and 910 can be used as a master mold to emboss the scattering surface onto the transparent substrate with an embossing resin, such as a polymeric resin that is UV or thermally curable to retain its surface features and provide desired scattering characteristics. Once dual sided embossing or thermal imprinting is done, one side (e.g., surface 905) can be metalized to provide a reflectively diffusing surface.

It is appreciated that the surfaces 905-910 effectively form two diffusers. Again, both surfaces/diffusers 905-910 have a nearly zero (e.g., smaller than one degree) scattering angle in the horizontal direction and a large angle (e.g., larger than thirty degrees) in the vertical direction, thereby producing great quality, continuous 3D images to viewers. It is also appreciated that in this embodiment, one of the surfaces of the diffuser 900 is metalized (e.g., aluminized) to effectively form a reflective glasses-free, continuous 3D display screen. This metalized surface may be, for example, the back surface of the diffuser 900 facing away from the projector(s) projecting the image thereon.

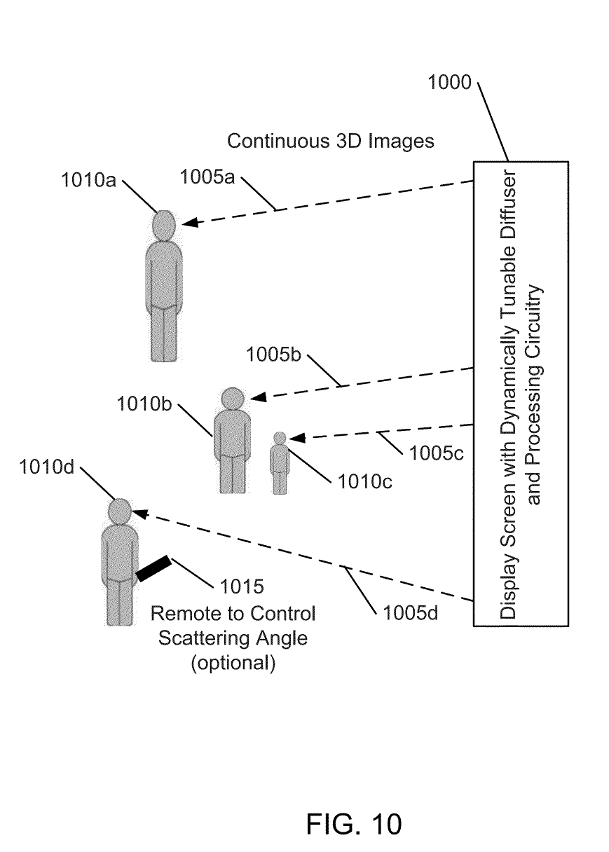

Referring now to FIG. 10, a display screen with a dynamically tunable diffuser is illustrated. Display screen 1000 is a display screen having a dynamically tunable diffuser as described herein above and processing circuitry to provide continuous, 3D images to viewers (e.g., continuous 3D images 1005a-d to viewers 1010a-d) without requiring the use of special viewing glasses.

The dynamically tunable diffuser may be, for example, diffuser 600 shown in FIG. 6, diffuser 700 shown in FIG. 7, diffuser 800 shown in FIG. 8, the diffuser 900 shown in FIG. 9, or any other dynamically tunable diffuser formed of two or more diffusers, with each diffuser having a nearly zero (e.g., smaller than one degree) scattering angle in the horizontal direction and a large angle (e.g., larger than thirty degrees) in the vertical direction, such that the microstructures in each diffuser are rotated relative to each other to allow the total scattering angle to be dynamically tuned. The processing circuitry may include any circuitry required for processing the data received from a capture and/or a transmission device (e.g., projector) and for processing the data required for display of the continuous, 3D images.

The total scattering angle of the dynamically tunable diffuser may be tuned in real-time by a viewer or be set in advance at one of many default values specified at fabrication, in the first case, a viewer may use a remote control to adjust the total scattering angle of the dynamically tunable diffuser as desired. For example, viewer 1010d may use remote control 1015 to adjust the total scattering angle of the display screen 1000 (such as described above with reference to FIG. 6). Alternatively, viewers may select the display screen 1000 out of many available display screens, by choosing one with a scattering angle that best fits their viewing needs.

It is appreciated that viewers of display screen 1000, such as viewers 1005a-d, may be of different heights (e.g., children and adult viewers alike) and located at different positions relative to display screen 1000. As such, having the dynamically tunable diffuser in the display screen 1000 enables continuous, good quality, 3D images to be displayed to everyone, regardless of their position and height, without requiring special viewing glasses, and without producing banding or other undesirable artifacts.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A dynamically tunable diffuser having a dynamically tunable scattering angle, the diffuser comprising:
a first diffuser having a first series of microstructures; and
at least one second diffuser integrated with the first diffuser and having a second series of microstructures, the second series of microstructures rotated relative to the first series of microstructures to provide an angle offset between the first diffuser and the at least one second diffuser.

2. The dynamically tunable diffuser of claim 1, wherein the first diffuser comprises a diffuser made of a reflective material.

3. The dynamically tunable diffuser of claim 1, wherein the first diffuser comprises a diffuser made of a transparent substrate.

4. The dynamically tunable diffuser of claim 1, wherein the at least one second diffuser comprises a diffuser made of a transparent substrate.

5. The dynamically tunable diffuser of claim 1, wherein the first diffuser is formed on a first surface of a transparent substrate and the at least one second diffuser comprises a diffuser formed on a second surface of the transparent substrate, the second surface opposite the first surface.

6. The dynamically tunable diffuser of claim 1, wherein the first series of microstructures comprises microstructures disposed along a surface of the first diffuser, the microstructures having a pattern and depth and spaced apart by a distance.

7. The dynamically tunable diffuser of claim 6, wherein the microstructures in the first series of microstructures have the same depth.

8. The dynamically tunable diffuser of claim 6, wherein the microstructures in the first series of microstructures have a variable depth.

9. The dynamically tunable diffuser of claim 6, wherein the microstructures in the first series of microstructures are equidistant.

10. The dynamically tunable diffuser of claim 6, wherein the microstructures in the first series of microstructures are spaced apart by a variable distance.

11. The dynamically tunable diffuser of claim 1, wherein the first diffuser and the at least one second diffuser comprise a horizontal scattering angle of nearly zero and a vertical scattering angle of at least thirty degrees in a vertical direction.

12. The dynamically tunable diffuser of claim 1, wherein the angle offset between the first diffuser and the at least one second diffuser is dynamically tuned by the rotation in the second series of microstructures in the at least one second diffuser relative to the first diffuser.

13. The dynamically tunable diffuser of claim 12, wherein the angle offset is dynamically tuned by a viewer of a display screen comprising the dynamically tunable diffuser.

14. A 3D display screen comprising:
a dynamically tunable diffuser, the dynamically tunable diffuser having a first diffuser and at least a second diffuser integrated together, the at least one second diffuser having a dynamically tuned angle offset relative to the first diffuser; and
processing circuitry to process and display continuous 3D images to viewers without requiring the use of special viewing glasses.

15. The 3D display screen of claim 14, wherein the first diffuser comprises a diffuser made of a reflective material.

16. The 3D display screen of claim 14, wherein the first diffuser comprises a diffuser made of a transparent substrate.

17. The 3D display screen of claim 14, wherein the at least one second diffuser comprises a diffuser made of a transparent substrate.

18. The 3D display screen of claim 14, wherein the first diffuser comprises a first series of microstructures disposed along a surface of the first diffuser and the at least second diffuser comprises a second series of microstructures rotate relative to the first series of microstructures by the angle offset.

19. A method of fabricating a dynamically tunable diffuser, the method comprising:
fabricating a first diffuser having a first series of microstructures;
fabricating at least one second diffuser having a second series of microstructures, the second series of microstructures rotated relative to the first series of microstructures to provide a dynamically tuned angle offset between the first diffuser and the at least one second diffuser; and
integrating the first diffuser together with the at least one second diffuser.

20. The method of claim 19, wherein integrating the first diffuser together with the at least one second diffuser comprises using an adhesive to attach the first diffuser to the at least one second diffuser.
